(19) United States
(12) Patent Application Publication
(10) Pub. No.: US 2004/0233343 A1
(43) Pub. Date: Nov. 25, 2004

(54) Liquid crystal display and thin film transistor array panel therefor

(75) Inventor: Seung-Soo Baek, Seoul (KR)

Correspondence Address: Frank Chau, F. CHAU & ASSOCIATES, LLP, 1900 Hempstead Turnpike, Suite 501, East Meadow, NY, 11554, US

(73) Assignee: Samsung Electronics Co., Ltd.

(21) Appl. No.: 10/848,298

(22) Filed: May 18, 2004

(30) Foreign Application Priority Data
May 19, 2003 (KR) 2003-0031628
May 20, 2003 (KR) 2003-0031835

(51) Int. Cl. G02F 1/1343

(52) U.S. Cl. 349/38

(57) ABSTRACT

A liquid crystal display is provided, which includes a thin film transistor array panel and a common electrode panel facing the thin film transistor array panel. The thin film transistor array panel includes a first gate line; a data line intersecting the gate line; a first thin film transistor including a gate electrode connected to the gate line, a source electrode connected to the data line, and a drain electrode; a first pixel electrode connected to the drain electrode; and a capacitor electrode overlapping at least one of the pixel electrode and the drain electrode with interposing an insulator. The common electrode panel includes a common electrode that faces the pixel electrode and has an opening facing at least one of the drain electrode and the capacitor electrode.

### BACKGROUND OF THE INVENTION

(a) Field of the Invention

The present invention relates to a liquid crystal display and a thin film transistor array panel therefor.

(b) Description of the Related Art

A liquid crystal display (LCD) is one of the most widely used flat panel displays. An LCD includes a liquid crystal (LC) layer interposed between a pair of panels provided with field-generating electrodes. The LC layer is subject to an electric field generated by the electrodes and variations in the field strength change the molecular orientation of the LC layer, which in turn change the polarization of light passing through the LC layer. Appropriately disposed polarizer(s) change the light transmittance based on the polarization of the light.

One measure of LCD quality is a viewing angle that is defined by angle where the LCD exhibits a predetermined contrast ratio. Various techniques for enlarging the viewing angle have been suggested, including a technique utilizing a vertically aligned LC layer and providing cutouts or protrusions at the field-generating electrodes such as pixel electrodes and a common electrode.

However, cutouts and the protrusions reduce the aperture ratio. To increase aperture ratio, it has been suggested that the size of the pixel electrodes be maximized. However, maximization of the size of the pixel electrodes results in a close distance between the pixel electrodes, causing strong lateral electric fields between the pixel electrodes. The strong electric fields cause unwanted altering of the orientation of the LC molecules, yielding textures and light leakage and deteriorating display characteristics. The textures and the light leakage may be screened by a wide black matrix, which also reduces the aperture ratio.

In the meantime, a pixel electrode and a common electrode form a capacitor interposing a liquid crystal layer called a LC capacitor, and a pixel electrode and a signal line provided on the panels form an auxiliary capacitor called a storage capacitor that is connected in parallel to the LC capacitor. The capacitances between the LC capacitor and the storage capacitor have appropriate values and appropriate ratios for sufficiently charging the capacitors.

However, the LC capacitance may be rapidly increased as the size of the LCD and the pixel electrodes increases since it is proportional to square of the pitch of the pixel electrodes. The increase of the LC capacitance decreases the charging rate of the LC capacitor and increases the response time of the liquid crystal. Although the decrease of the charging rate may be compensated by increasing the storage capacitance and the increase of the response time may be compensated by increasing the width of the cutouts or the protrusions, it causes the decrease of the aperture ratio.

### SUMMARY OF THE INVENTION

A motivation of the present invention is to provide an LCD having optimized LC capacitance.

Another motivation of the present invention is to provide an LCD having sufficient aperture ratio.

Another motivation of the present invention is to provide an LCD having stable liquid crystal alignment.

Another motivation of the present invention is to provide a pixel configuration easily applicable to any LCD.

A liquid crystal display is provided, which includes a thin film transistor array panel and a common electrode panel facing the thin film transistor array panel. The thin film transistor array panel includes a first gate line; a data line intersecting the gate line; a first thin film transistor including a gate electrode connected to the gate line, a source electrode connected to the data line, and a drain electrode; a first pixel electrode connected to the drain electrode; and a capacitor electrode overlapping at least one of the pixel electrode and the drain electrode with interposing an insulator. The common electrode panel includes a common electrode that faces the pixel electrode and has an opening facing at least one of the drain electrode and the capacitor electrode.

The data line may include a curved portion and an intersecting portion connected to the curved portion and intersecting the gate line. The curved portion of the data line may include a pair of rectilinear portions connected to each other and making an angle of about 45 degrees with the gate line. The pixel electrode may be curved along the curved portion of the data line.

The pixel electrode may overlap the data line at least in part.

The liquid crystal display may further include: a second gate line separated from the first gate line and the data line and disposed adjacent to the first pixel electrode; a second thin film transistor connected to the second gate line; a second pixel electrode connected to the second thin film transistor.

The capacitor electrode may be connected to the second gate line and the liquid crystal display may further include a capacitor conductor electrically connected to the pixel electrode and disposed between the capacitor electrode and the pixel electrode.

However, the capacitor electrode may be disconnected from the second gate line.

The liquid crystal display may further include a color filter disposed on either of the thin film transistor array panel and the common electrode panel.

The liquid crystal display may further include a liquid crystal layer interposed between the thin film transistor array panel and the common electrode panel.

The liquid crystal layer may have negative anisotropy and substantially vertical alignment. The liquid crystal display may further include a tilt control member controlling tilt directions of molecules in the liquid crystal layer, and the tilt control member may include a cutout in the pixel electrode or the common electrode, or a protrusion on the pixel electrode or the common electrode.

The liquid crystal display may further include a semiconductor layer disposed opposite the gate electrode and including a first portion located between the source electrode and the drain electrode. The semiconductor layer may further include a second portion disposed under the data line. The semiconductor layer may have substantially the same planar pattern as the data line, the source electrode, and the drain electrode except for the first portion.

A thin film transistor array panel is provided, which includes: a substrate; a gate line formed on the substrate and including a gate electrode; a data line formed on the substrate and including a curved portion and an intersecting portion crossing the gate line; a thin film transistor including a gate electrode connected to the gate line, a source electrode connected to the data line, and a drain electrode; a pixel electrode connected to the drain electrode; and a storage electrode overlapping at least one of the pixel electrode and the drain electrode with interposing an insulator, wherein at least one of the drain electrode and the storage electrode includes a portion extending parallel to the curved portion of the data line.

The curved portion of the data line comprises a pair of portions making a clockwise angle of about 45 degrees and a counterclockwise angle of about 45 degrees with respect to the gate line, respectively.

The drain electrode and the storage electrode may overlap each other.

The source electrode may be connected to the intersecting portion of the data line.

The pixel electrode may be curved along the curved portion of the data line.

The pixel electrode may overlap the data line at least in part.

The pixel electrode may include a pair partitions interposing a cutout therebetween.

The thin film transistor array panel may further include a semiconductor layer disposed opposite the gate electrode and including a first portion located between the source electrode and the drain electrode. The semiconductor layer may further include a second portion disposed under the data line. The semiconductor layer may have substantially the same planar pattern as the data line, the source electrode, and the drain electrode except for the first portion.

A liquid crystal display is provided, which includes a thin film transistor array panel and a common electrode panel facing the thin film transistor array panel. The thin film transistor array panel includes: a substrate; a gate line formed on the substrate and including a gate electrode; a data line formed on the substrate and including a curved portion and an intersecting portion crossing the gate line; a thin film transistor including a gate electrode connected to the gate line, a source electrode connected to the data line, and a drain electrode; a pixel electrode connected to the drain electrode; and a storage electrode overlapping at least one of the pixel electrode and the drain electrode with interposing an insulator. The common electrode panel includes a common electrode that faces the pixel electrode.

The liquid crystal display may further include a color filter disposed on either of the thin film transistor array panel and the common electrode panel.

The liquid crystal display may further include a liquid crystal layer interposed between the thin film transistor array panel and the common electrode panel and having negative anisotropy and substantially vertical alignment. The liquid crystal display may further include a tilt control member controlling tilt directions of molecules in the liquid crystal layer. The tilt control member may include a cutout in the pixel electrode or the common electrode, or a protrusion on the pixel electrode or the common electrode.

The tilt control member may be curved in parallel to the data line. The tilt control member faces at least one of the drain electrode and the storage electrode.

### BRIEF DESCRIPTION OF THE DRAWINGS

The present invention will become more apparent by describing embodiments thereof in detail with reference to the accompanying drawings in which:

FIG. 1 is a layout view of a TFT array panel for an LCD according to an embodiment of the present invention;

FIG. 2 is a layout view of a common electrode panel for an LCD according to an embodiment of the present invention;

FIG. 3 is a layout view of an LCD including the TFT array panel shown in FIG. 1 and the common electrode panel shown in FIG. 2;

FIG. 4 is a sectional view of the LCD shown in FIG. 3 taken along the line IV-IV′;

FIG. 5 is a sectional view of the LCD shown in FIG. 3 taken along the lines V-V′ and V′-V″;

FIG. 6 is a layout view of a TFT array panel for an LCD according to another embodiment of the present invention;

FIG. 7 is a sectional view of an LCD including the TFT array panel shown in FIG. 6 taken along the line VII-VII′;

FIG. 8 is a sectional view of an LCD including the TFT array panel shown in FIG. 6 taken along the lines VIII-VIII′ and VIII′-VIII″;

FIG. 9 is a layout view of an LCD according to another embodiment of the present invention;

FIG. 10 is a sectional view of the LCD shown in FIG. 9 taken along the line X-X′;

FIG. 11 is a layout view of an LCD according to another embodiment of the present invention;

FIG. 12 is a sectional view of the LCD shown in FIG. 11 taken along the line XII-XII′;

FIG. 13 is a layout view of an LCD according to another embodiment of the present invention;

FIG. 14 is a sectional view of the LCD shown in FIG. 13 taken along the line XIV-XIV′;

FIG. 15 is a sectional view of the LCD shown in FIG. 13 taken along the lines XV-XV′ and XV′-XV″;

FIG. 16 is a layout view of an LCD according to another embodiment of the present invention;

FIG. 17 is a sectional view of a TFT array panel of the LCD shown in FIG. 16 taken along the line XVII-XVII′;

FIG. 18 is a layout view of a TFT array panel for an LCD according to another embodiment of the present invention;

FIG. 19 is a layout view of a common electrode panel for an LCD according to another embodiment of the present invention;

FIG. 20 is a layout view of an LCD including the TFT array panel shown in FIG. 18 and the common electrode panel shown in FIG. 19;

FIG. 21 is a sectional view of the LCD shown in FIG. 20 taken along the line XXI-XXI′;

FIG. 22 is a sectional view of the LCD shown in FIG. 20 taken along the lines XXII-XXII′ and XXII′-XXII″;

FIG. 23 is a layout view of a TFT array panel for an LCD according to another embodiment of the present invention;

FIG. 24 is a sectional view of an LCD including the TFT array panel shown in FIG. 23 taken along the line XXIV-XXIV′;

FIG. 25 is a sectional view of an LCD including the TFT array panel shown in FIG. 23 taken along the lines XXV-XXV′ and XXV′-XXV″;

FIG. 26 is a layout view of an LCD according to another embodiment of the present invention; and

FIG. 27 is a sectional view of the LCD shown in FIG. 26 taken along the line XXVII-XXVII′.

### DETAILED DESCRIPTION OF EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

Now, liquid crystal displays and thin film transistor (TFT) array panels for LCDs according to embodiments of the present invention will be described with reference to the accompanying drawings.

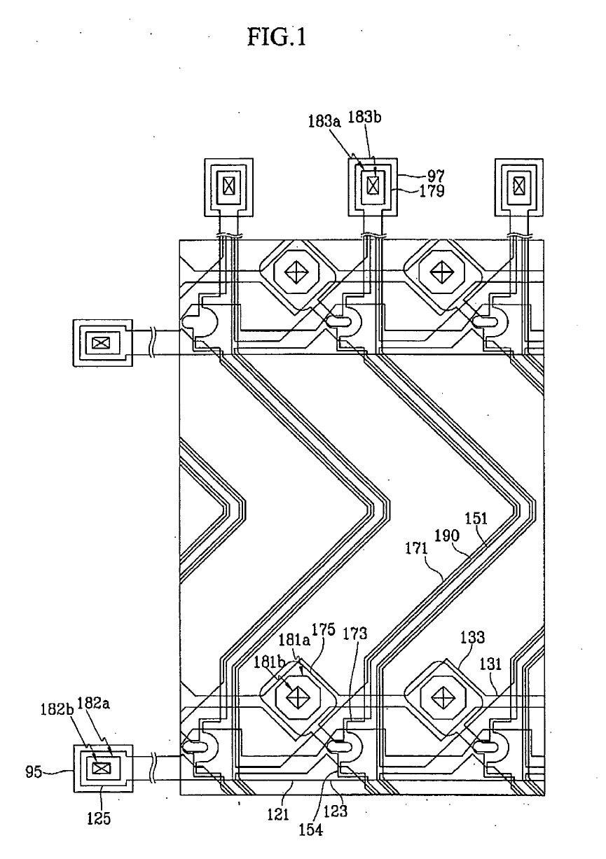

An LCD according to an embodiment of the present invention is described in detail with reference to FIGS. 1-5.

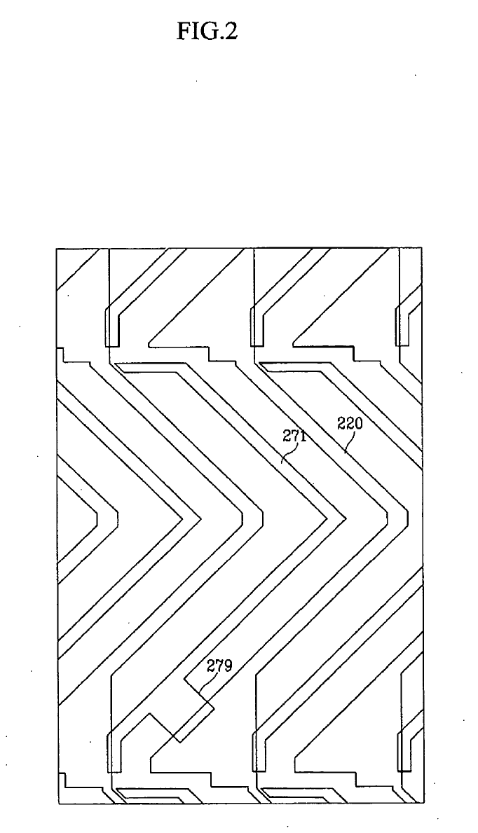

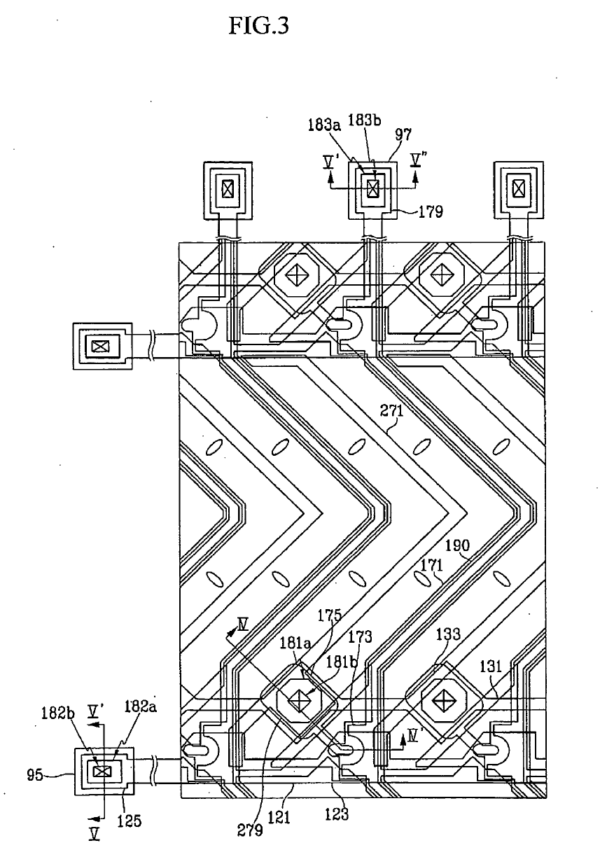

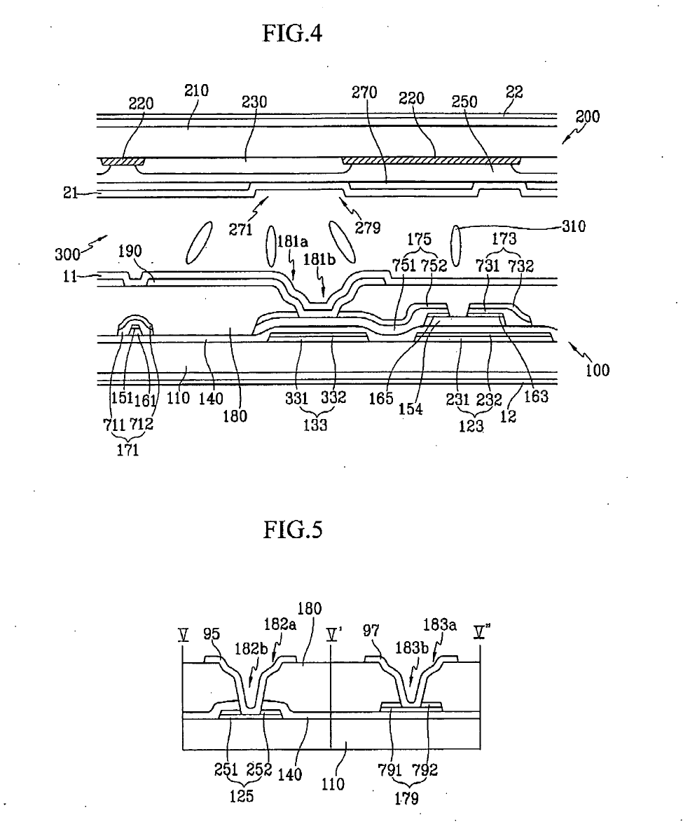

FIG. 1 is a layout view of a TFT array panel for an LCD according to an embodiment of the present invention, FIG. 2 is a layout view of a common electrode panel for an LCD according to an embodiment of the present invention, FIG. 3 is a layout view of an LCD including the TFT array panel shown in FIG. 1 and the common electrode panel shown in FIG. 2, FIG. 4 is a sectional view of the LCD shown in FIG. 3 taken along the line IV-IV′, and FIG. 5 is a sectional view of the LCD shown in FIG. 3 taken along the lines V-V′ and V′-V″.

An LCD according to an embodiment of the present invention includes a TFT array panel 100, a common electrode panel 200 facing the TFT array panel 100, and a LC layer 300 interposed between the TFT array panel 100 and the common electrode panel 200.

The TFT array panel 100 is now described in detail with reference to FIGS. 1, 4 and 5.

A plurality of gate lines 121 and a plurality of storage electrode lines 131 are formed on an insulating substrate 110.

The gate lines 121 extend substantially in a transverse direction and are separated from each other and transmit gate signals. Each gate line 121 includes a plurality of projections forming a plurality of gate electrodes 123 and an end portion 125 having a large area for contact with another layer or an external device.

Each storage electrode line 131 extends substantially in the transverse direction and includes a plurality of projections forming storage electrodes 133. Each storage electrode 133 has a shape of a diamond or a rectangle rotated by about 45 degrees and they are located close to the gate lines 121. The storage electrode lines 131 are supplied with a predetermined voltage such as a common voltage, which is applied to a common electrode 270 on the common electrode panel 200 of the LCD.

The gate lines 121 and the storage electrode lines 131 have a multi-layered structure including two films having different physical characteristics, a lower film and an upper film. The upper film is preferably made of low resistivity metal including Al containing metal such as Al and Al alloy, Ag containing metal such as Ag and Ag alloy, or Cu containing metal such as Cu and Cu alloy for reducing signal delay or voltage drop in the gate lines 121 and the storage electrode lines 131. On the other hand, the lower film is preferably made of material such as Cr, Mo, Mo alloy, Ta, or Ti, which has good physical, chemical, and electrical contact characteristics with other materials such as indium tin oxide (ITO) or indium zinc oxide (IZO). A good exemplary combination of the lower film material and the upper film material is Cr and Al—Nd alloy. In FIG. 4, the lower and the upper films of the gate electrodes 123 are indicated by reference numerals 231 and 232, respectively, the lower and the upper films of the end portions 125 are indicated by reference numerals 251 and 252, respectively, and the lower and the upper films of the storage electrodes 133 are indicated by reference numerals 331 and 332, respectively. Portions of the upper film 252 of the end portions 125 of the gate lines 121 are removed to expose the underlying portions of the lower films 251.

The gate lines 121 and the storage electrode lines 131 may have a single layer structure or may include three or more layers.

In addition, the lateral sides of the gate lines 121 and the storage electrode lines 131 are inclined relative to a surface of the substrate 110, and the inclination angle thereof ranges about 30-80 degrees.

A gate insulating layer 140 preferably made of silicon nitride (SiNx) is formed on the gate lines 121 and the storage electrode lines 131.

A plurality of semiconductor stripes 151 preferably made of hydrogenated amorphous silicon (abbreviated as “a-Si”) or polysilicon are formed on the gate insulating layer 140. Each semiconductor stripe 151 extends substantially in the longitudinal direction while it is curved periodically. Each semiconductor stripe 151 has a plurality of projections 154 branched out toward the gate electrodes 123.

A plurality of ohmic contact stripes and islands 161 and 165 preferably made of silicide or n+ hydrogenated a-Si heavily doped with n type impurity such as phosphorous (P) are formed on the semiconductor stripes 151. Each ohmic contact stripe 161 has a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are inclined relative to the surface of the substrate 110, and the inclination angles thereof are preferably in a range between about 30-80 degrees.

A plurality of data lines 171 and a plurality of drain electrodes 175 separated from each other are formed on the ohmic contacts 161 and 165 and the gate insulating layer 140.

The data lines 171 for transmitting data voltages extend substantially in the longitudinal direction and intersect the gate lines 121 and the storage electrode lines 131. Each data line 171 has an end portion 179 having a large area for contact with another layer or an external device and it includes a plurality of pairs of oblique portions and a plurality of longitudinal portions such that it curves periodically. A pair of oblique portions are connected to each other to form a chevron and opposite ends of the pair of oblique portions are connected to respective longitudinal portions. The oblique portions of the data lines 171 make an angle of about 45 degrees with the gate lines 121, and the longitudinal portions cross over the gate electrodes 123. The length of a pair of oblique portions is about one to nine times the length of a longitudinal portion, that is, it occupies about 50-90 percents of the total length of the pair of oblique portions and the longitudinal portion.

Each drain electrode 175 includes a rectangular or rhombic expansion overlapping a storage electrode 133. The edges of the expansion of the drain electrode 175 are substantially parallel to the edges of the storage electrodes 133. Each longitudinal portion of the data lines 171 includes a plurality of projections such that the longitudinal portion including the projections forms a source electrode 173 partly enclosing an end portion of a drain electrode 175. Each set of a gate electrode 123, a source electrode 173, and a drain electrode 175 along with a projection 154 of a semiconductor stripe 151 form a TFT having a channel formed in the semiconductor projection 154 disposed between the source electrode 173 and the drain electrode 175.

The data lines 171 and the drain electrodes 175 also include a lower film 711 and 751 preferably made of Mo, Mo alloy or Cr and an upper film 712 and 752 located thereon and preferably made of Al containing metal. In FIGS. 4 and 5, the lower and the upper films of the source electrodes 173 are indicated by reference numerals 731 and 732, respectively, and the lower and the upper films of the end portions 179 of the data lines 171 are indicated by reference numerals 791 and 792, respectively. Portion of the upper films 792, 752 of the expansions 179 of the data lines 171 and the drain electrodes 175 are removed to expose the underlying portions of the lower films 791 and 751.

Like the gate lines 121 and the storage electrode lines 131, the data lines 171 and the drain electrodes 175 have inclined lateral sides, and the inclination angles thereof range about 30-80 degrees.

The ohmic contacts 161 and 165 are interposed only between the underlying semiconductor stripes 151 and the overlying data lines 171 and the overlying drain electrodes 175 thereon and reduce the contact resistance therebetween.

A passivation layer 180 is formed on the data lines 171 and the drain electrodes 175, and exposed portions of the semiconductor stripes 151, which are not covered with the data lines 171 and the drain electrodes 175. The passivation layer 180 is preferably made of photosensitive organic material having a good flatness characteristic, low dielectric insulating material such as a-Si:C:O and a-Si:O:F formed by plasma enhanced chemical vapor deposition (PECVD), or inorganic material such as silicon nitride and silicon oxide. The passivation layer 180 may have a double-layered structure including a lower inorganic film and an upper organic film.

The passivation layer 180 has a plurality of contact holes 181b and 183b exposing the drain electrodes 175 and the end portions 179 of the data lines 171, respectively. The passivation layer 180 and the gate insulating layer 140 have a plurality of contact holes 182b exposing the end portions 125 of the gate lines 121. The contact holes 181b, 182b and 183b can have various shapes such as polygon or circle. The area of each contact hole 182b or 183b is preferably equal to or larger than about 0.5 mm×15 μm and not larger than about 2 mm×60 μm. The sidewalls 181a, 182a and 183a of the contact holes 181b, 182b and 183b are inclined with an angle of about 30-85 degrees or have stepwise profiles.

A plurality of pixel electrodes 190 and a plurality of contact assistants 95 and 97, which are preferably made of ITO or IZO, are formed on the passivation layer 180. Alternatively, the pixel electrodes 191 may be made of transparent conductive polymer, and, for a reflective LCD, the pixel electrodes 191 are made of opaque reflective metal. In these cases, the contact assistants 192 and 199 may be made of material such as ITO or IZO different from the pixel electrodes 191.

Each pixel electrode 190 is located substantially in an area enclosed by the data lines 171 and the gate lines 121, and thus it also forms a chevron. The pixel electrodes 190 cover the storage electrode lines 131 including the storage electrodes 133 and the expansions of the drain electrodes 175 and have chamfered edges substantially parallel to edges of the storage electrodes 133 that are close to the chamfered edges.

The pixel electrodes 190 are physically and electrically connected to the drain electrodes 175 through the contact holes 181b such that the pixel electrodes 190 receive the data voltages from the drain electrodes 175. The pixel electrodes 190 supplied with the data voltages generate electric fields in cooperation with the common electrode 270, which reorient liquid crystal molecules 310 disposed therebetween.

A pixel electrode 190 and a common electrode form a capacitor called a “liquid crystal capacitor,” which stores applied voltages after turn-off of the TFT. An additional capacitor called a “storage capacitor,” which is connected in parallel to the liquid crystal capacitor, is provided for enhancing the voltage storing capacity. The storage capacitors are implemented by overlapping the pixel electrodes 190 with the storage electrode lines 131. The capacitances of the storage capacitors, i.e., the storage capacitances are increased by providing the projections (i.e., the storage electrodes) 133 at the storage electrode lines 131, elongating the drain electrodes 175 connected to the pixel electrodes 190, and providing the expansions at the drain electrodes 175 overlapping the storage electrodes 133 of the storage electrode lines 131 for decreasing the distance between the terminals and increasing the overlapping areas.

The pixel electrodes 190 overlap the data lines 171 as well as the gate lines 121 to increase aperture ratio.

The contact assistants 95 and 97 are connected to the exposed end portions 125 of the gate lines 121 and the exposed end portions 179 of the data lines 171 through the contact holes 181b and 182b, respectively. The contact assistants 95 and 97 protect the exposed portions 125 and 179 and complement the adhesiveness of the exposed portions 125 and 179 and external devices.

Finally, an alignment layer 11 is formed on the pixel electrodes 190 and the passivation layer 180.

The description of the common electrode panel 200 follows with reference to FIGS. 2, 4 and 5.

A light blocking member called a black matrix 220 is formed on an insulating substrate 210 such as transparent glass and it includes a plurality of oblique portions facing the oblique portions of the data lines 171 and a plurality of right-angled-triangular portions facing the TFTs and the longitudinal portions of the data lines 171 such that the light blocking member 220 prevents light leakage between the pixel electrodes 190 and defines open areas facing the pixel electrodes 190. Each of the triangular portions of the light blocking member 220 has a hypotenuse parallel to a chamfered edge of a pixel electrode 190.

A plurality of color filters 230 are formed on the substrate 210 and the light blocking member 220 and it is disposed substantially in the open areas defined by the light blocking member 220. The color filters 230 disposed in adjacent two data lines 171 and arranged in the longitudinal direction may be connected to each other to form a stripe. Each color filter 230 may represent one of three primary colors such as red, green and blue colors.

An overcoat 250 preferably made of organic material is formed on the color filters 230 and the light blocking member 220. The overcoat 250 protects the color filters 230 and has a flat top surface.

A common electrode 270 preferably made of transparent conductive material such as ITO and IZO is formed on the overcoat 250. The common electrode 270 is supplied with the common voltage and it has a plurality of chevron-like cutouts 271 and a plurality of rectangular or rhombic openings 279.

Each cutout 271 includes a pair of oblique portions connected to each other, a transverse portion connected to one of the oblique portions, and a longitudinal portion connected to the other of the oblique portions. The oblique portions of the cutout 271 extend substantially parallel to the oblique portions of the data lines 171 and face a pixel electrode 190 so that they may bisect the pixel electrode 190 into left and right halves. The transverse and the longitudinal portions of the cutout 271 are aligned with transverse and longitudinal edges of the pixel electrode 190, respectively, and they make obtuse angles with the oblique portions of the cutout 190. The cutouts 271 are provided for controlling the tilt directions of the LC molecules 310 in the LC layer 300 and preferably have a width in a range between about 9-12 microns. The cutouts 271 may be substituted with protrusions preferably made of organic material and preferably having width ranging about 5 microns to 10 microns.

The openings 279 face the pixel electrodes 190 opposite the drain electrodes 175 or the storage electrodes 133 such that the capacitances of the LC capacitors are reduced without decreasing the aperture ratio. The figures show that each opening 279 is connected to a cutout 271, but it may not.

When a pixel electrode 190 is enlarged, the capacitance of an associated LC capacitor is also increased. The increase of the LC capacitance in turn increases the charging time of the LC capacitor, thereby decreasing the charging rate thereof. Furthermore, the capacitance of an associated storage capacitor needs to be increased for maintaining the capacitance ratio between the LC capacitor and the storage capacitor. The increase of the storage capacitance requires a larger overlapping area between the pixel electrode 190 and an associated storage electrode 133, and thus a larger area of the storage electrode 133, thereby decreasing the aperture ratio. Accordingly, the opening 279 prevents the increase of the LC capacitance and thus the increase of the storage capacitance, thereby increasing the charging rate of the LC capacitor and the aperture ratio.

A homogeneous or homeotropic alignment layer 21 is coated on the common electrode 270.

A pair of polarizers 12 and 22 are provided on outer surfaces of the panels 100 and 200 such that their transmissive axes are crossed and one of the transmissive axes is parallel to the gate lines 121.

The LCD may further include at least one retardation film for compensating the retardation of the LC layer 300 and a backlight unit for providing light for the LCD.

The LC layer 300 has negative dielectric anisotropy and the LC molecules 310 in the LC layer 300 are aligned such that their long axes are substantially vertical to the surfaces of the panels 100 and 200 in absence of electric field.

Upon application of the common voltage to the common electrode 270 and a data voltage to the pixel electrodes 190, a primary electric field substantially perpendicular to the surfaces of the panels 100 and 200 is generated. The LC molecules 310 tend to change their orientations in response to the electric field such that their long axes are perpendicular to the field direction. In the meantime, the cutouts 271 of the common electrode 270 and the edges of the pixel electrodes 190 distort the primary electric field to have a horizontal component which determines the tilt directions of the LC molecules 310. The horizontal component of the primary electric field is perpendicular to the edges of the cutouts 271 and the edges of the pixel electrodes 190.

Accordingly, four sub-regions having different tilt directions, which are partitioned by edges of a pixel electrode 190, a cutout 271 bisecting the pixel electrode 190, and an imaginary transverse center line passing through the meeting point of the oblique portions of the cutout 271, are formed in a pixel region of the LC layer 300, which are located on the pixel electrode 190. Each sub-region has two major edges defined by the cutout 271 and an oblique edge of the pixel electrode 190, respectively, which are spaced apart preferably from about 10 microns to about 30 microns. The number of the sub-regions in a pixel region is preferably four if the planar area of the pixel region is smaller than about 100×300 square microns, and, if not, it is preferably four or eight. The number of the sub-regions can be varied by changing the number of the cutouts 271 of the common electrode 270, by providing cutouts at the pixel electrodes 190, or by changing the number of curved points of the edges of the pixel electrodes 190. The sub-regions are classified into a plurality of, preferably four, domains based on the tilt directions.

In the meantime, the direction of a secondary electric field due to the voltage difference between the pixel electrodes 190 is perpendicular to the edges of the cutouts 271. Accordingly, the field direction of the secondary electric field coincides with that of the horizontal component of the primary electric field. Consequently, the secondary electric field between the pixel electrodes 190 enhances the determination of the tilt directions of the LC molecules 310.

Since the LCD performs inversion such as dot inversion, column inversion, etc., adjacent pixel electrodes are supplied with data voltages having opposite polarity with respect to the common voltage and thus a secondary electric field between the adjacent pixel electrodes is almost always generated to enhance the stability of the domains.

Since the tilt directions of all domains make an angle of about 45 degrees with the gate lines 121, which are parallel to or perpendicular to the edges of the panels 100 and 200, and the 45-degree intersection of the tilt directions and the transmissive axes of the polarizers gives maximum transmittance, the polarizers can be attached such that the transmissive axes of the polarizers are parallel to or perpendicular to the edges of the panels 100 and 200 and it reduces the production cost.

The resistance increase of the data lines 171 due to the curving can be compensated by widening the data lines 171 since distortion of the electric field and increase of the parasitic capacitance due to the increase of the width of the data lines 171 can be compensated by maximizing the size of the pixel electrodes 190 and by adapting a thick organic passivation layer.

The LCD shown in FIGS. 1-5 can have several modifications.

For example, the pixel electrodes 191 as well as the common electrode 270 may have cutouts (not shown) for generating fringe field. Furthermore, the cutouts may be substituted with protrusions disposed on the common electrode 270 or the pixel electrodes 190.

The shapes and the arrangements of the cutouts or the protrusions may be varied depending on the design factors such as the size of pixels, the ratio of the transverse edges and the longitudinal edges of the pixel electrodes, the type and characteristics of the liquid crystal layer 3, and so on.

As another example of the modification, the pixel electrodes 190 and the common electrode 270 may have no cutout or protrusion for controlling the molecular tilt directions of the LC layer.

As still another example of the modification, the LC layer 300 may has positive dielectric anisotropy and is aligned in a twisted nematic mode, where the LC molecules therein are aligned parallel to surfaces of the panels 100 and 200 and twisted by an approximately right angle from the TFT array panel 100 to the common electrode panel 200 in absence of electric field.

As further another example of the modification, the pixel electrodes 190, the data lines 171, the semiconductor stripes 151, the ohmic contact stripes 161, the light blocking members 220, the color filters 230, etc., may be straight or rectangular rather than curved, oblique, rhombic, or parallelogrammic.

A method of manufacturing the TFT array panel shown in FIGS. 1-5 according to an embodiment of the present invention will be now described in detail.

First, a lower conductive film preferably made of Cr, Mo, or Mo alloy and an upper conductive film preferably made of Al containing metal or Ag containing metal are sputtered in sequence on an insulating substrate 110 and they are wet or dry etched in sequence to form a plurality of gate lines 121, each including a plurality of gate electrodes 123 and an expansion 125, and a plurality of storage electrode lines 131 including a plurality of storage electrodes 133.

After sequential chemical vapor deposition of a gate insulating layer 140 with thickness of about 1,500-5,000 Å, an intrinsic a-Si layer with thickness of about 500-2,000 Å, and an extrinsic a-Si layer with thickness of about 300-600 Å, the extrinsic a-Si layer and the intrinsic a-Si layer are photo-etched to form a plurality of extrinsic semiconductor stripes and a plurality of intrinsic semiconductor stripes 151 including a plurality of projections 154 on the gate insulating layer 140.

Subsequently, two conductive films including a lower conductive film and an upper conductive film and having a thickness of 1,500-3,000 Å are sputtered in sequence and patterned to form a plurality of date lines 171, each including a plurality of source electrodes 173 and an expansion 179, and a plurality of drain electrodes 175. The lower conductive film is preferably made of Cr, Mo, or Mo alloy, and the upper conductive film is preferably made of Al containing metal or Ag containing metal.

Thereafter, portions of the extrinsic semiconductor stripes, which are not covered with the data lines 171 and the drain electrodes 175, are removed to complete a plurality of ohmic contact stripes 161 including a plurality of projections 163 and a plurality of ohmic contact islands 165 and to expose portions of the intrinsic semiconductor stripes 151. Oxygen plasma treatment preferably follows in order to stabilize the exposed surfaces of the semiconductor stripes 151.

Next, a passivation layer 180 made of a photosensitive organic insulator is coated and exposed through a photo-mask having a plurality of transmissive areas and a plurality of slit areas disposed around the transmissive areas. Accordingly, portions of the passivation layer 180 facing the transmissive areas absorb the full energy of the light, while portions of the passivation layer 180 facing the slit areas partially absorb the light energy. The passivation layer 180 is then developed to form a plurality of contact holes 181b and 183b exposing portions of the drain electrodes 175 and portions of the expansions 179 of the data lines 171, respectively, and to form upper portions of a plurality of contact holes 182b exposing portions of the gate insulating layer 140 disposed on the expansions 125 of the gate lines 121. Since the portions of the passivation layer 180 facing the transmissive areas are removed to its full thickness, while the portions facing the slit areas remain to have reduced thickness, sidewalls 181a, 182a and 183a of the contact holes 181b, 182b and 183b have stepped profiles.

After removing the exposed portions of the gate insulating layer 140 to expose the underlying portions of the expansions 125 of the gate insulating layer 140, the exposed portions of the upper conductive films 752, 792 and 252 of the drain electrodes 175, the expansions 179 of the data lines 171, and the expansions 125 of the gate lines 121 are removed to expose underlying portions of the lower conductive films 751, 791 and 251 of the drain electrodes 175, the expansions 179 of the data lines 171, and the expansions 125 of the gate lines 121.

Finally, a plurality of pixel electrodes 190 and a plurality of contact assistants 92 and 97 are formed on the passivation layer 180 and on the exposed portions of the lower conductive films 751, 791 and 251 of the drain electrodes 175, the expansions 125 of the gate lines 121, and the expansions 179 of the data lines 171 by sputtering and photo-etching an IZO or ITO layer with thickness of about 400-500 Å.

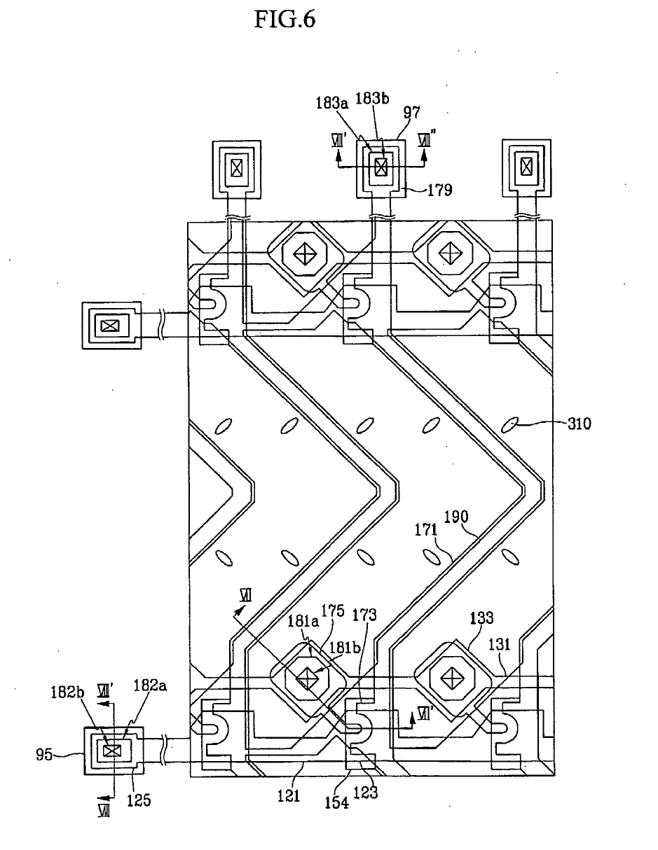

An LCD according to another embodiment of the present invention will be described in detail with reference to FIGS. 6-8.

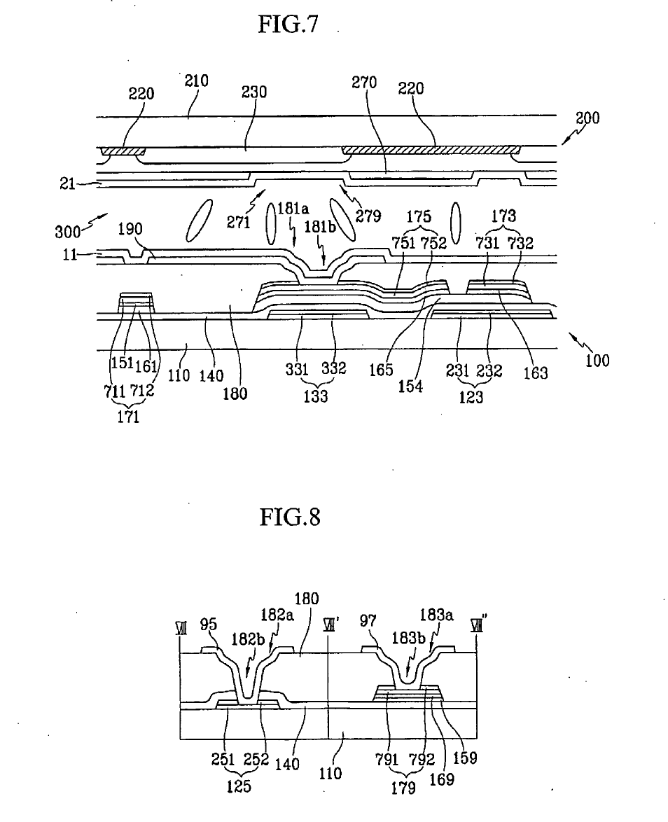

FIG. 6 is a layout view of a TFT array panel for an LCD according to another embodiment of the present invention, FIG. 7 is a sectional view of an LCD including the TFT array panel shown in FIG. 6 taken along the line VII-VII′, and FIG. 8 is a sectional view of an LCD including the TFT array panel shown in FIG. 6 taken along the lines VIII-VIII′ and VIII′-VIII″.

Referring to FIGS. 6-8, an LCD according to this embodiment also includes a TFT array panel 100, a common electrode panel 200, and a LC layer 300 interposed therebetween.

Layered structures of the panels 100 and 200 according to this embodiment are almost the same as those shown in FIGS. 1-5. In particular, the common electrode panel 200 may have substantially the same layout as that shown in FIG. 2.

Regarding the TFT array panel 100, a plurality of gate lines 121 including a plurality of gate electrodes 123 and a plurality of storage electrode lines 131 including a plurality of storage electrodes 133 are formed on a substrate 110, and a gate insulating layer 140, a plurality of semiconductor stripes 151 including a plurality of projections 154, and a plurality of ohmic contact stripes 161 including a plurality of projections 163 and a plurality of ohmic contact islands 165 are sequentially formed thereon. A plurality of data lines 171 including a plurality of source electrodes 173 and a plurality of drain electrodes 175 including expansions are formed on the ohmic contacts 161 and 165, and a passivation layer 180 is formed thereon. A plurality of contact holes 181b, 182b and 183b are provided at the passivation layer 180 and the gate insulating layer 140, and a plurality of pixel electrodes 190 and a plurality of contact assistants 95 and 97 are formed on the passivation layer 180. An alignment layer 11 is formed thereon.

Regarding the common electrode panel 200, a light blocking member 220, a plurality of color filters 230, an overcoat 250, a common electrode 270 having a plurality of openings 279, and an alignment layer 21 are formed on an insulating substrate 210.

Different from the LCD shown in FIGS. 1-5, the semiconductor stripes 151 have almost the same planar shapes as the data lines 171 and the drain electrodes 175 as well as the underlying ohmic contacts 161 and 165. However, the projections 154 of the semiconductor stripes 151 include some exposed portions, which are not covered with the data lines 171 and the drain electrodes 175, such as portions located between the source electrodes 173 and the drain electrodes 175.

A manufacturing method of the TF array panel according to an embodiment simultaneously forms the data lines 171, the drain electrodes 175, the semiconductors 151, and the ohmic contacts 161 and 165 using one photolithography process.

A photoresist pattern for the photolithography process has position-dependent thickness, and in particular, it has first and second portions with decreased thickness. The first portions are located on wire areas that will be occupied by the data lines 171 and the drain electrodes 175 and the second portions are located on channel areas of TFTs.

The position-dependent thickness of the photoresist is obtained by several techniques, for example, by providing translucent areas on the exposure mask 300 as well as transparent areas and light blocking opaque areas. The translucent areas may have a slit pattern, a lattice pattern, a thin film(s) with intermediate transmittance or intermediate thickness. When using a slit pattern, it is preferable that the width of the slits or the distance between the slits is smaller than the resolution of a light exposer used for the photolithography. Another example is to use reflowable photoresist. In detail, once a photoresist pattern made of a reflowable material is formed by using a normal exposure mask only with transparent areas and opaque areas, it is subject to reflow process to flow onto areas without the photoresist, thereby forming thin portions.

As a result, the manufacturing process is simplified by omitting a photolithography step.

Many of the above-described features of the LCD shown in FIGS. 1-5 may be appropriate to the LCD shown in FIGS. 6-8.

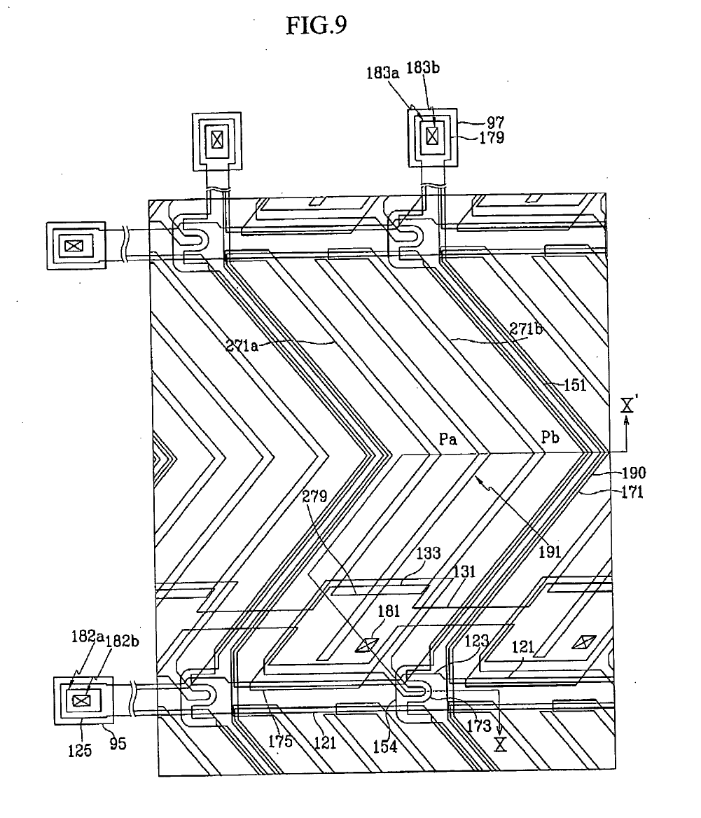

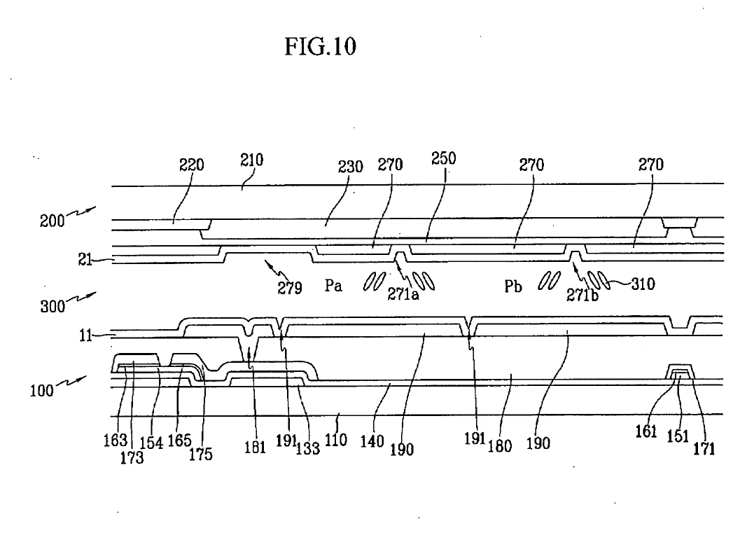

An LCD according to another embodiment of the present invention will be described in detail with reference to FIGS. 9 and 10.

FIG. 9 is a layout view of an LCD according to another embodiment of the present invention, and FIG. 10 is a sectional view of the LCD shown in FIG. 9 taken along the line X-X′.

Referring to FIGS. 9 and 10, an LCD according to this embodiment also includes a TFT array panel 100, a common electrode panel 200, and a LC layer 300 interposed therebetween.

Layered structures of the panels 100 and 200 according to this embodiment are almost the same as those shown in FIGS. 1-5.

Regarding the TFT array panel 100, a plurality of gate lines 121 including a plurality of gate electrodes 123 and a plurality of storage electrode lines 131 including a plurality of storage electrodes 133 are formed on a substrate 110, and a gate insulating layer 140, a plurality of semiconductor stripes 151 including a plurality of projections 154, and a plurality of ohmic contact stripes 161 including a plurality of projections 163 and a plurality of ohmic contact islands 165 are sequentially formed thereon. A plurality of data lines 171 including a plurality of source electrodes 173 and a plurality of drain electrodes 175 including expansions are formed on the ohmic contacts 161 and 165, and a passivation layer 180 is formed thereon. A plurality of contact holes 181, 182b and 183b are provided at the passivation layer 180 and the gate insulating layer 140, and a plurality of pixel electrodes 190 and a plurality of contact assistants 95 and 97 are formed on the passivation layer 180. An alignment layer 11 is formed thereon.

Regarding the common electrode panel 200, a light blocking member 220, a plurality of color filters 230, an overcoat 250, a common electrode 270 having a plurality of openings 279, and an alignment layer 21 are formed on an insulating substrate 210.

Different from the LCD shown in FIGS. 1-5, each pixel electrode 190 has a cutout 191. Each cutout 191 includes a pair of oblique portions that extending parallel to the data lines 171 and bisects the pixel electrode 190 into left and right partitions forming pairs of subpixel areas Pa and Pb. In addition, the common electrode 270 has a plurality of pairs of cutouts 271a and 271b parallel to the cutouts 191 and bisecting the partitions of the pixel electrodes 190 into left and right portions. The figures show that a pair of cutouts 271a and 271b are connected by an opening 279 at their ends.

In addition, the storage electrodes 133, the expansions of the drain electrodes 175, the contact holes 181 exposing portions of the drain electrodes 175, and the openings 279 have shapes of parallelogram.

Although the figures show that a pair of partitions forming a pixel electrode 190 are interposed between adjacent data lines 171, the partitions may be separated by a data line 171.

Many of the above-described features of the LCD shown in FIGS. 1-5 may be appropriate to the LCD shown in FIGS. 9 and 10.

Although FIGS. 1-10 show that the pixel electrodes 190, the data lines 171, etc., are curved, they may be straight or orthogonal. In addition, the shape and the arrangement of the cutouts 271 and the openings 279 may be modified.

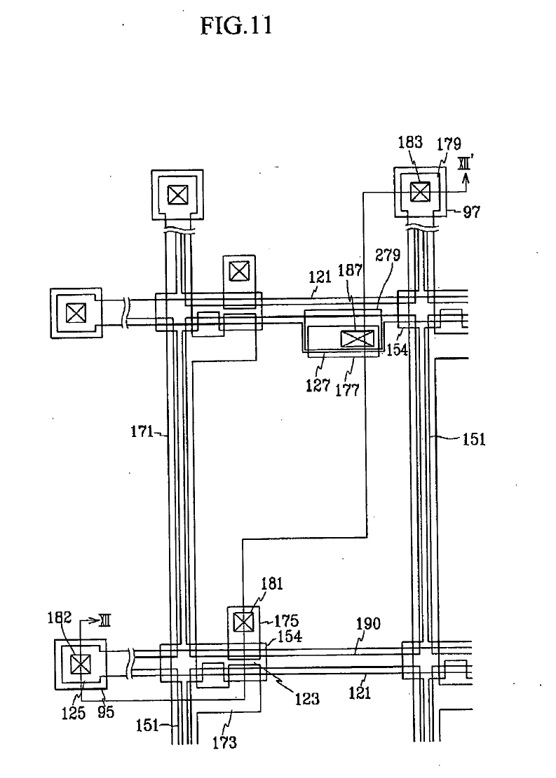

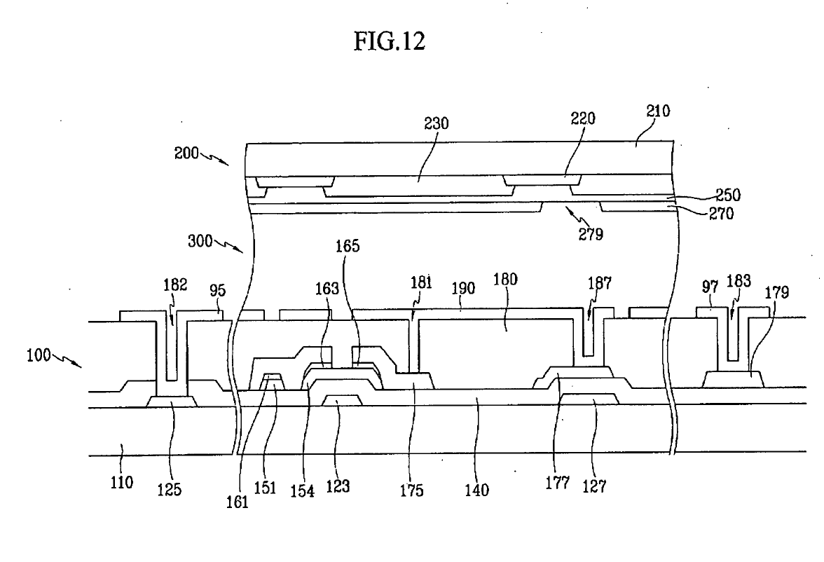

An LCD according to another embodiment of the present invention will be described in detail with reference to FIGS. 11 and 12.

FIG. 11 is a layout view of an LCD according to another embodiment of the present invention, and FIG. 12 is a sectional view of the LCD shown in FIG. 11 taken along the line XII-XII′.

Referring to FIGS. 11 and 12, an LCD according to this embodiment also includes a TFT array panel 100, a common electrode panel 200, and a LC layer 300 interposed therebetween.

Layered structures of the panels 100 and 200 according to this embodiment are almost the same as those shown in FIGS. 1-5.

Regarding the TFT array panel 100, a plurality of gate lines 121 including a plurality of gate electrodes 123 are formed on a substrate 110, and a gate insulating layer 140, a plurality of semiconductor stripes 151 including a plurality of projections 154, and a plurality of ohmic contact stripes 161 including a plurality of projections 163 and a plurality of ohmic contact islands 165 are sequentially formed thereon. A plurality of data lines 171 including a plurality of source electrodes 173 and a plurality of drain electrodes 175 are formed on the ohmic contacts 161 and 165, and a passivation layer 180 is formed thereon. A plurality of contact holes 181, 182 and 183 are provided at the passivation layer 180 and the gate insulating layer 140, and a plurality of pixel electrodes 190 and a plurality of contact assistants 95 and 97 are formed on the passivation layer 180.

Regarding the common electrode panel 200, a light blocking member 220, a plurality of color filters 230, an overcoat 250, and a common electrode 270 having a plurality of openings 279 are formed on an insulating substrate 210.

Different from the LCD shown in FIGS. 1-5, the pixel electrodes 190, the data lines 171, the semiconductor stripes 151, the ohmic contact stripes 161, the light blocking members 220, the color filters 230, etc., are straight or rectangular rather than curved, oblique, rhombic, or parallelogrammic.

In addition, the pixel electrodes 190 and the common electrode 270 have no cutout or protrusion for obtaining multi-domains and the LC layer 300 preferably has positive dielectric anisotropy and is aligned in a twisted nematic mode, where the LC molecules therein are aligned parallel to surfaces of the panels 100 and 200 and twisted by an approximately right angle from the TFT array panel 100 to the common electrode panel 200 in absence of electric field. However, it is merely an option.

Furthermore, the LCD has no storage electrode line for forming storage capacitors. Instead, each gate line 121 has a plurality of projections 127 protruding downward to overlap the pixel electrodes 190, thereby forming storage capacitors, and a plurality of storage capacitor conductors 177 connected to the pixel electrodes 190 through contact holes 187 in the passivation layer 180 are interposed between the pixel electrodes 190 and the projections 127 to increase the storage capacitances. However, the LCD may include storage electrode lines under the lack of the storage capacitance.

The openings 279 face the projections 127 and the storage capacitor conductors 177 instead of the drain electrodes 175.

The gate lines 121, the data lines 171, the drain electrodes 175, and the storage capacitor conductors 177 consist of a single layer although they may have a multilayered structure. The gate lines 121 are preferably made of Al containing metal, Ag containing metal, Cu containing metal, Cr, Mo, Mo alloy, Ta, or Ti, and the data lines 171 are preferably made of refractory metal such as Cr, Mo, Mo alloy, Ta and Ti.

The figures show that the semiconductor stripes 151 becomes widened near the gate lines 121 although they are narrower than the data lines 171 at most places, such that the surface profile is smoothed to prevent the disconnection of the data lines 171.

Many of the above-described features of the LCD shown in FIGS. 1-5 may be appropriate to the LCD shown in FIGS. 11 and 12.

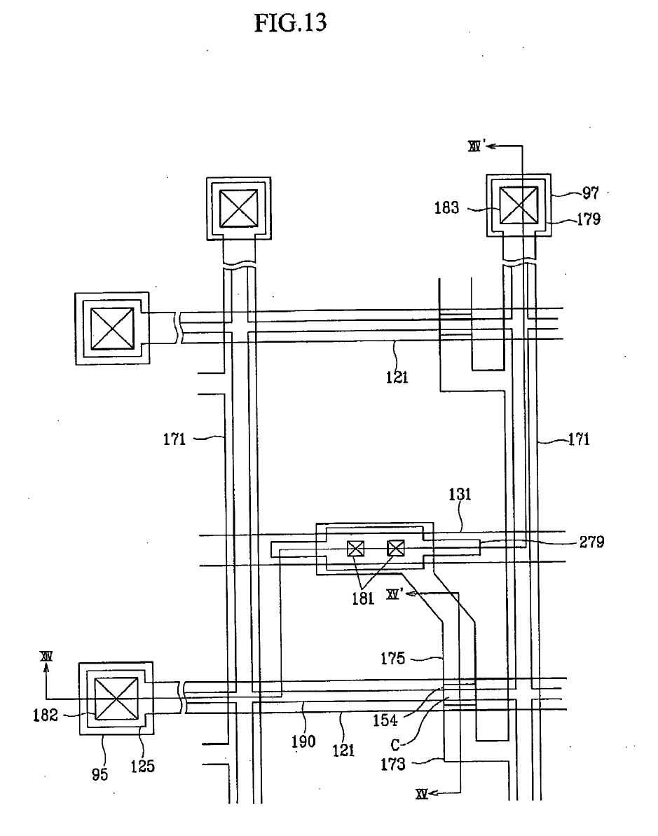

An LCD according to another embodiment of the present invention will be described in detail with reference to FIGS. 13-15.

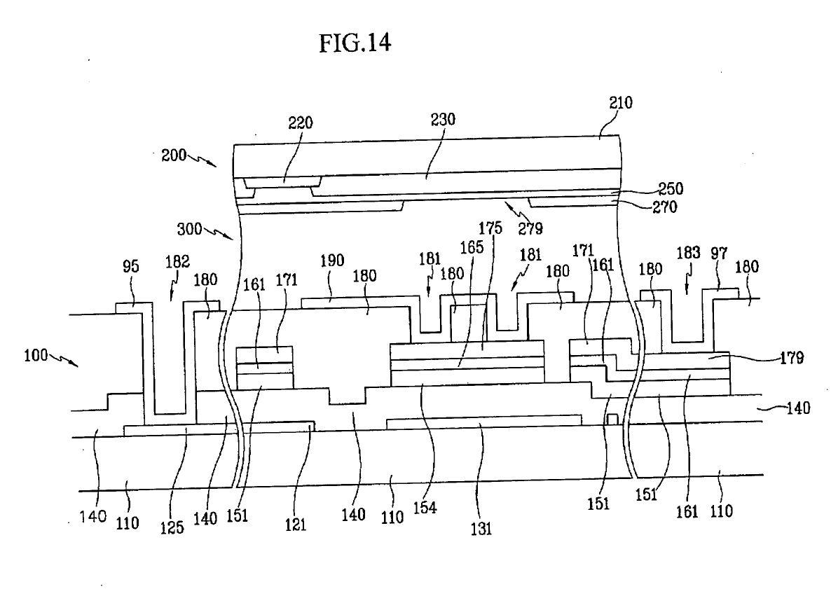

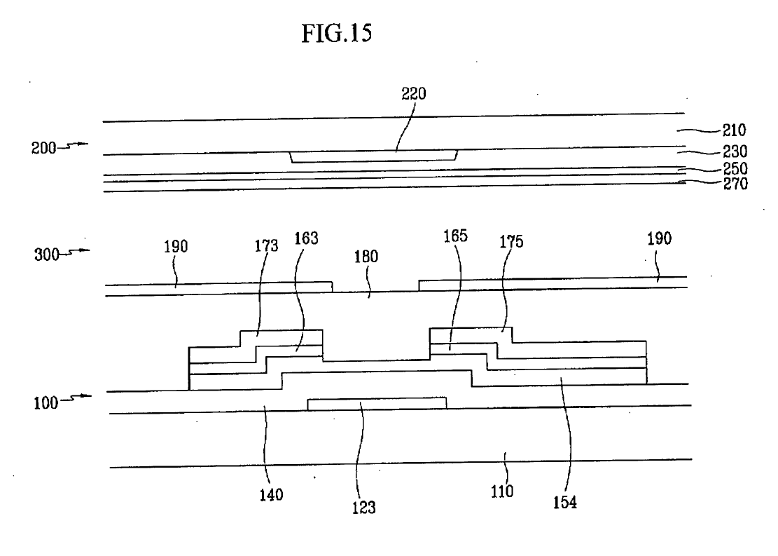

FIG. 13 is a layout view of an LCD according to another embodiment of the present invention, FIG. 14 is a sectional view of the LCD shown in FIG. 13 taken along the line XIV-XIV′, and FIG. 15 is a sectional view of the LCD shown in FIG. 13 taken along the lines XV-XV′ and XV′-XV″.

Referring to FIGS. 13-15, an LCD according to this embodiment also includes a TFT array panel 100, a common electrode panel 200, and a LC layer 300 interposed therebetween.

Layered structures of the panels 100 and 200 according to this embodiment are almost the same as those shown in FIGS. 11 and 12.

Regarding the TFT array panel 100, a plurality of gate lines 121 including a plurality of gate electrodes 123 are formed on a substrate 110, and a gate insulating layer 140, a plurality of semiconductor stripes 151 including a plurality of projections 154, and a plurality of ohmic contact stripes 161 including a plurality of projections 163 and a plurality of ohmic contact islands 165 are sequentially formed thereon. A plurality of data lines 171 including a plurality of source electrodes 173 and a plurality of drain electrodes 175 are formed on the ohmic contacts 161 and 165, and a passivation layer 180 is formed thereon. A plurality of contact holes 181, 182 and 183 are provided at the passivation layer 180 and the gate insulating layer 140, and a plurality of pixel electrodes 190 and a plurality of contact assistants 95 and 97 are formed on the passivation layer 180.

Regarding the common electrode panel 200, a light blocking member 220, a plurality of color filters 230, an overcoat 250, and a common electrode 270 having a plurality of openings 279 are formed on an insulating substrate 210.

Different from the LCD shown in FIGS. 11 and 12, the TFT array panel according to this embodiment provides a plurality of storage electrode lines 131, which are separated from the gate lines 121, on the same layer as the gate lines 121 without projections of the gate lines 121. The storage electrode lines 131 are supplied with a predetermined voltage such as the common voltage. In addition, without providing the storage capacitor conductors 177 shown in FIGS. 11 and 12, the drain electrodes 175 extend to overlap the storage electrode lines 131 to form storage capacitors. The storage electrode lines 131 may be omitted if the storage capacitance generated by the overlapping of the gate lines 121 and the pixel electrodes 191 is sufficient.

The openings 279 face the expansions of the drain electrodes 175 and the storage electrode lines 131.

Furthermore, the semiconductor stripes 151 have almost the same planar shapes as the data lines 171 and the drain electrodes 175 as well as the underlying ohmic contacts 161 and 165. However, the projections 154 of the semiconductor stripes 151 include some exposed portions, which are not covered with the data lines 171 and the drain electrodes 175, such as portions located between the source electrodes 173 and the drain electrodes 175.

Many of the above-described features of the LCD shown in FIGS. 11 and 12 may be appropriate to the LCD shown in FIGS. 13-15.

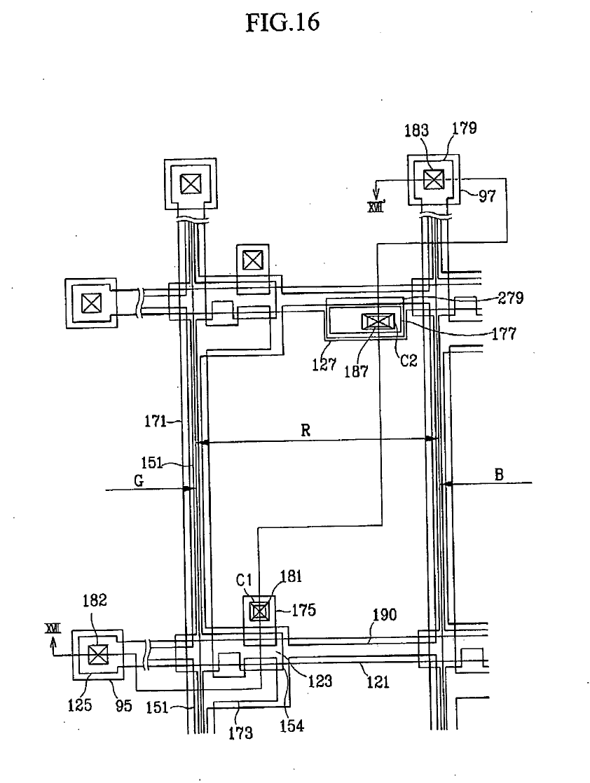

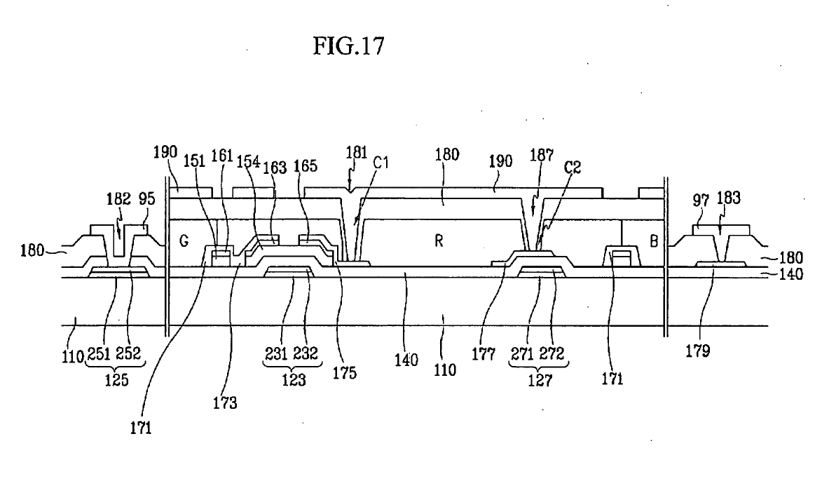

An LCD according to another embodiment of the present invention will be described in detail with reference to FIGS. 16 and 17.

FIG. 16 is a layout view of an LCD according to another embodiment of the present invention and FIG. 17 is a sectional view of a TFT array panel of the LCD shown in FIG. 16 taken along the line XVII-XVII′.

Referring to FIGS. 16 and 17, an LCD according to this embodiment also includes a TFT array panel 100, a common electrode panel (not shown), and a LC layer (not shown) interposed therebetween.

Layered structures of the panels according to this embodiment are almost the same as those shown in FIGS. 11 and 12.

Regarding the TFT array panel 100, a plurality of gate lines 121 including a plurality of gate electrodes 123 and a plurality of projections 127 are formed on a substrate 110, and a gate insulating layer 140, a plurality of semiconductor stripes 151 including a plurality of projections 154, and a plurality of ohmic contact stripes 161 including a plurality of projections 163 and a plurality of ohmic contact islands 165 are sequentially formed thereon. A plurality of data lines 171 including a plurality of source electrodes 173, a plurality of drain electrodes 175, and a plurality of storage capacitor conductors 177 are formed on the ohmic contacts 161 and 165 and the gate insulating layer 140, and a passivation layer 180 is formed thereon. A plurality of contact holes 181, 182, 183 and 187 are provided at the passivation layer 180 and the gate insulating layer 140, and a plurality of pixel electrodes 190 and a plurality of contact assistants 95 and 97 are formed on the passivation layer 180.

Regarding the common electrode panel, a light blocking member (not shown), and a common electrode (not shown) having a plurality of openings 279 are formed on an insulating substrate 210.

Different from the LCD shown in FIGS. 11 and 12, the TFT array panel according to this embodiment provides a plurality of red, green and blue color filter stripes R, G and B under the passivation layer 180, while there is no color filter on the common electrode panel. Each of the color filter stripes R, G and B are disposed substantially between adjacent two the data lines 171 and extends in a longitudinal direction. The color filter stripes R, G and B have a plurality of openings C1 and C2 exposing the drain electrodes 175 and the storage capacitor conductors 177 and surrounding the contact holes 181 and 187, respectively. However, the contact holes 181 and 187 may fully expose the openings C1 and C2 and may further expose top surface of the color filters R, G and B, thereby smoothing the profiles of the contacts between the pixel electrodes 190 and the drain electrodes 175 and the storage capacitor conductors 177. The color filter stripes R, G and B are not disposed on a peripheral area which is provided with expanded end portions 125 and 179 of the gate lines 121 and the data lines 179. Although the figures show that edges of adjacent color filter stripes R, G and B exactly match each other, the color filter stripes R, G and B may overlap each other on the data lines 171 to enhance the light blocking or they may be spaced apart from each other.

Furthermore, there is no overcoat on the common electrode panel, but it is optional.

The gate lines 121 include a lower film preferably made of low resistivity material such as Al containing metal, Ag containing metal, and Cu containing metal and an upper film preferably made of good contact material such as Cr, Mo, Mo alloy, Ta or Ti. In FIG. 17, the lower and the upper films of the gate electrodes 123 are indicated by reference numerals 231 and 232, respectively, the lower and the upper films of the end portions 125 are indicated by reference numerals 251 and 252, respectively, and the lower and the upper films of the projections 127 are indicated by reference numerals 271 and 272, respectively.

Many of the above-described features of the LCD shown in FIGS. 11 and 12 may be appropriate to the LCD shown in FIGS. 16 and 17.

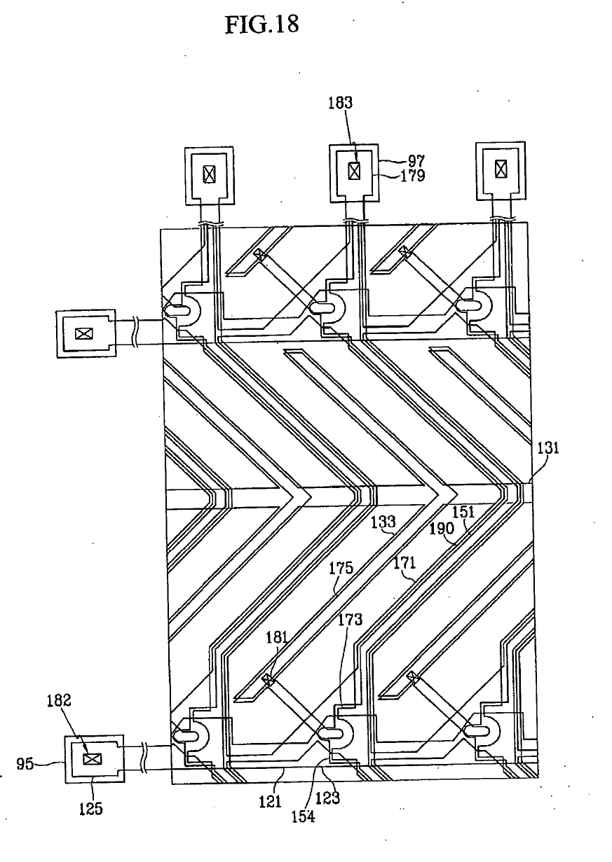

An LCD according to another embodiment of the present invention will be described in detail with reference to FIGS. 18-22.

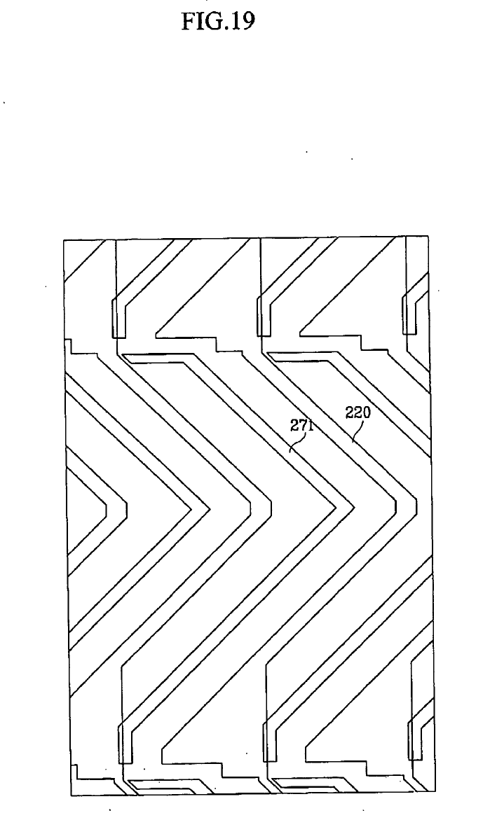

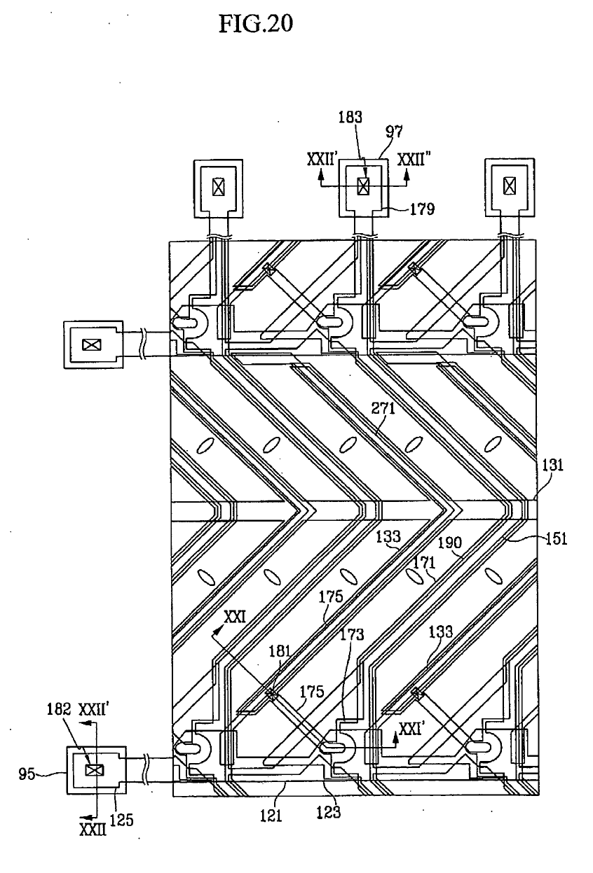

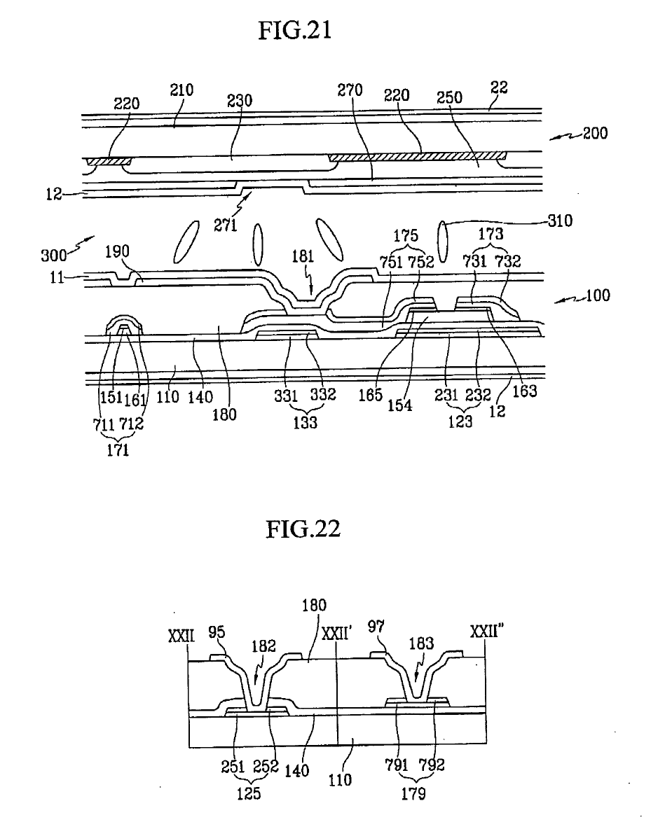

FIG. 18 is a layout view of a TFT array panel for an LCD according to another embodiment of the present invention, FIG. 19 is a layout view of a common electrode panel for an LCD according to another embodiment of the present invention, FIG. 20 is a layout view of an LCD including the TFT array panel shown in FIG. 18 and the common electrode panel shown in FIG. 19, FIG. 21 is a sectional view of the LCD shown in FIG. 20 taken along the line XXI-XXI′, and FIG. 22 is a sectional view of the LCD shown in FIG. 20 taken along the lines XXII-XXII′ and XXII′-XXII″.

Referring to FIGS. 18-22, an LCD according to this embodiment also includes a TFT array panel 100, a common electrode panel 200, and a LC layer 300 interposed therebetween.

Layered structures of the panels 100 and 200 according to this embodiment are almost the same as those shown in FIGS. 1-5.

Regarding the TFT array panel 100, a plurality of gate lines 121 including a plurality of gate electrodes 123 and a plurality of storage electrode lines 131 are formed on a substrate 110, and a gate insulating layer 140, a plurality of semiconductor stripes 151 including a plurality of projections 154, and a plurality of ohmic contact stripes 161 including a plurality of projections 163 and a plurality of ohmic contact islands 165 are sequentially formed thereon. A plurality of data lines 171 including a plurality of source electrodes 173 and a plurality of drain electrodes 175 are formed on the ohmic contacts 161 and 165, and a passivation layer 180 is formed thereon. A plurality of contact holes 181, 182 and 183 are provided at the passivation layer 180 and the gate insulating layer 140, and a plurality of pixel electrodes 190 and a plurality of contact assistants 95 and 97 are formed on the passivation layer 180. An alignment layer 11 is formed thereon.

Regarding the common electrode panel 200, a light blocking member 220, a plurality of color filters 230, an overcoat 250, a common electrode 270 having a plurality of cutouts 271, and an alignment layer 21 are formed on an insulating substrate 210.

Different from the LCD shown in FIGS. 1-5, the storage electrode lines 131 are disposed near the center of the pixel electrodes 190 and they include a plurality of branches that obliquely extend upward and downward in parallel to the data lines 171 to form storage electrodes 133. In addition, the drain electrodes 175 are also elongated along the storage electrodes 133, and the storage electrodes 133 and the drain electrodes 175 overlap the cutouts 271 of the common electrode 270. However, the pixel electrodes 190 have no separate rectangular, rhombic, or parallelogrammic opening.

Since the storage electrodes 133 overlap the drain electrodes 175 through a long distance, sufficiently large storage capacitance is obtained. Furthermore, the elongation of the storage electrodes 133 and the drain electrodes 175 do not cause the reduction of the aperture ratio since they overlap the cutouts 271. Accordingly, the aperture ratio can be rather increased by the omission of the openings in the common electrode 270 compared with that shown in FIGS. 1-5.

In addition, the freedom of the pixel design and the storage capacitance is high since the storage electrode 133 and the drain electrode are disposed at a boundary of domains.

Many of the above-described features of the LCD shown in FIGS. 1-5 may be appropriate to the LCD shown in FIGS. 18-22.

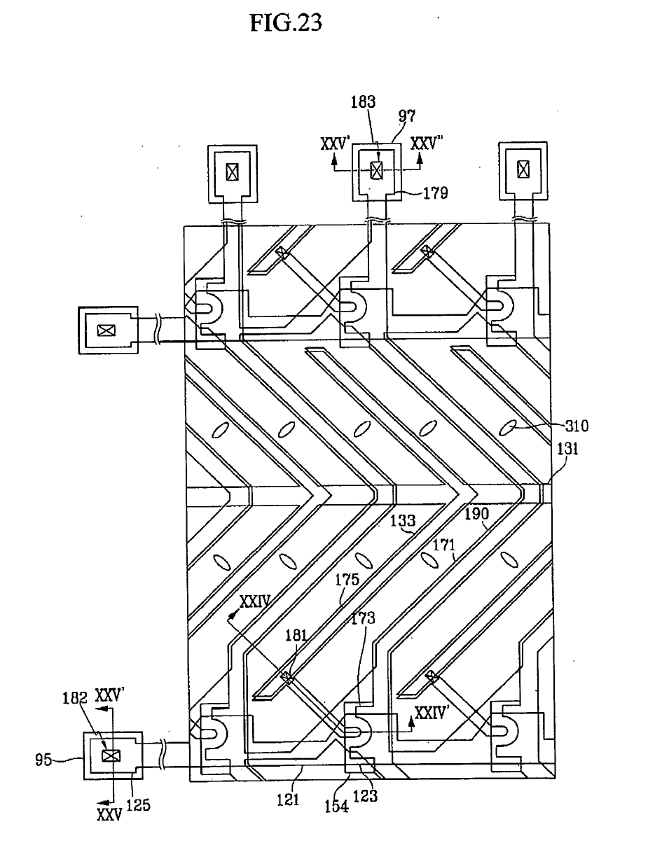

An LCD according to another embodiment of the present invention will be described in detail with reference to FIGS. 23-25.

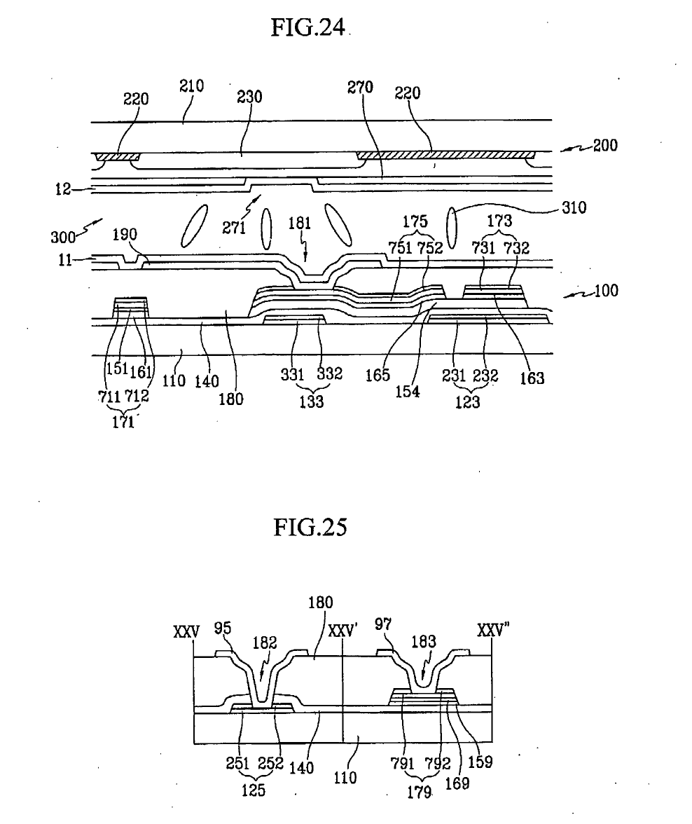

FIG. 23 is a layout view of a TFT array panel for an LCD according to another embodiment of the present invention, FIG. 24 is a sectional view of an LCD including the TFT array panel shown in FIG. 23 taken along the line XXIV-XXIV′, and FIG. 25 is a sectional view of an LCD including the TFT array panel shown in FIG. 23 taken along the lines XXV-XXV′ and XXV′-XXV″.

Referring to FIGS. 23-25, an LCD according to this embodiment also includes a TFT array panel 100, a common electrode panel 200, and a LC layer 300 interposed therebetween.

Layered structures of the panels 100 and 200 according to this embodiment are almost the same as those shown in FIGS. 18-22. In particular, the common electrode panel 200 may have substantially the same layout as that shown in FIG. 19.

Regarding the TFT array panel 100, a plurality of gate lines 121 including a plurality of gate electrodes 123 and a plurality of storage electrode lines 131 including a plurality of storage electrodes 133 are formed on a substrate 110, and a gate insulating layer 140, a plurality of semiconductor stripes 151 including a plurality of projections 154, and a plurality of ohmic contact stripes 161 including a plurality of projections 163 and a plurality of ohmic contact islands 165 are sequentially formed thereon. A plurality of data lines 171 including a plurality of source electrodes 173 and a plurality of drain electrodes 175 are formed on the ohmic contacts 161 and 165, and a passivation layer 180 is formed thereon. A plurality of contact holes 181, 182 and 183 are provided at the passivation layer 180 and the gate insulating layer 140, and a plurality of pixel electrodes 190 and a plurality of contact assistants 95 and 97 are formed on the passivation layer 180. An alignment layer 11 is formed thereon.

Regarding the common electrode panel 200, a light blocking member 220, a plurality of color filters 230, an overcoat 250, a common electrode 270 having a plurality of cutouts 271, and an alignment layer 21 are formed on an insulating substrate 210.

Different from the LCD shown in FIGS. 18-22, the semiconductor stripes 151 have almost the same planar shapes as the data lines 171 and the drain electrodes 175 as well as the underlying ohmic contacts 161 and 165. However, the projections 154 of the semiconductor stripes 151 include some exposed portions, which are not covered with the data lines 171 and the drain electrodes 175, such as portions located between the source electrodes 173 and the drain electrodes 175.

Many of the above-described features of the LCD shown in FIGS. 18-22 may be appropriate to the LCD shown in FIGS. 23-25.

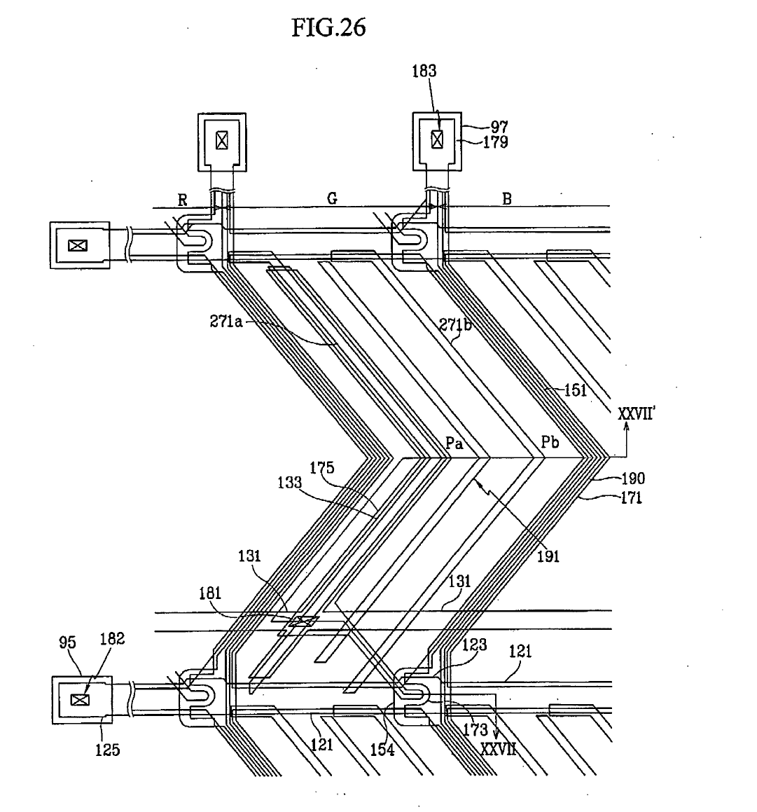

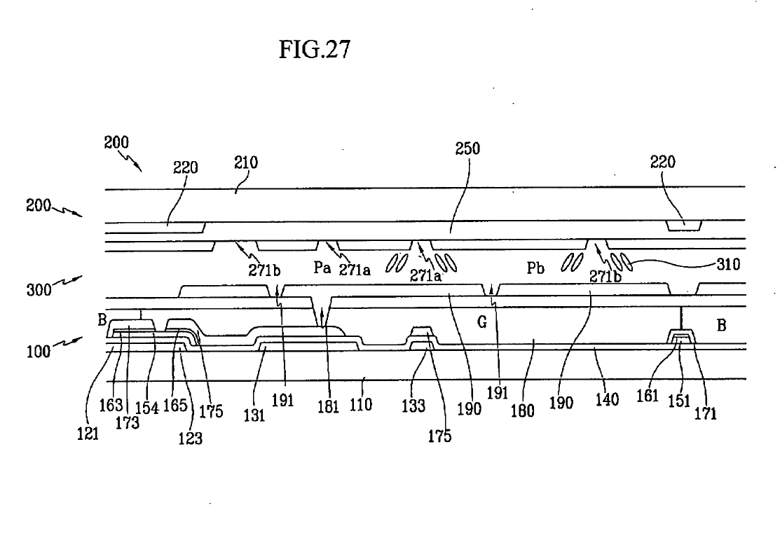

An LCD according to another embodiment of the present invention will be described in detail with reference to FIGS. 26 and 27.

FIG. 26 is a layout view of an LCD according to another embodiment of the present invention, and FIG. 27 is a sectional view of the LCD shown in FIG. 26 taken along the line XXVII-XXVII′.

Referring to FIGS. 26 and 27, an LCD according to this embodiment also includes a TFT array panel 100, a common electrode panel 200, and a LC layer 300 interposed therebetween.

Layered structures of the panels 100 and 200 according to this embodiment are almost the same as those shown in FIGS. 18-22.

Regarding the TFT array panel 100, a plurality of gate lines 121 including a plurality of gate electrodes 123 and a plurality of storage electrode lines 131 including a plurality of storage electrodes 133 are formed on a substrate 110, and a gate insulating layer 140, a plurality of semiconductor stripes 151 including a plurality of projections 154, and a plurality of ohmic contact stripes 161 including a plurality of projections 163 and a plurality of ohmic contact islands 165 are sequentially formed thereon. A plurality of data lines 171 including a plurality of source electrodes 173 and a plurality of drain electrodes 175 are formed on the ohmic contacts 161 and 165, and a passivation layer 180 is formed thereon. A plurality of contact holes 181, 182 and 183 are provided at the passivation layer 180 and the gate insulating layer 140, and a plurality of pixel electrodes 190 and a plurality of contact assistants 95 and 97 are formed on the passivation layer 180.

Regarding the common electrode panel 200, a light blocking member 220, an overcoat 250, and a common electrode 270 having a plurality of cutouts 271 are formed on an insulating substrate 210.

Different from the LCD shown in FIGS. 18-22, each pixel electrode 190 has a cutout 191. Each cutout 191 includes a pair of oblique portions that extending parallel to the data lines 171 and bisects the pixel electrode 190 into left and right partitions forming pairs of subpixel areas Pa and Pb. In addition, the common electrode 270 has a plurality of pairs of cutouts 271a and 271b parallel to the cutouts 191 and bisecting the partitions of the pixel electrodes 190 into left and right portions.

The storage electrode lines 131 are disposed near the gate lines 121 and each storage electrode 133 overlap a left cutout 271a of the common electrode 270. However, the storage electrode 133 may overlap a right cutout 271b of the common electrode 270 or a cutout 191 of a pixel electrode 190.

The storage electrode lines 131 may further include additional storage electrodes (not shown) overlapping the cutouts 191 or 271b and, in this case, the drain electrodes 175 may include branches (not shown) overlapping the addition storage electrodes.

The storage electrodes 133 may be shorter than those shown in FIG. 26, and for example, they may terminate near the center of the pixel electrodes 190.

In addition, a plurality of red, green and blue color filter stripes R, G and B is formed under the passivation layer 180, while there is no color filter on the common electrode panel. Each of the color filter stripes R, G and B are disposed substantially between adjacent two the data lines 171 and extends in a longitudinal direction to be periodically curved along the data lines 171. The contact holes 181 also penetrate the color filter stripes R, G and B to expose the drain electrodes 175. The color filter stripes R, G and B are not disposed on a peripheral area which is provided with expanded end portions 125 and 179 of the gate lines 121 and the data lines 179. Although the figures show that edges of adjacent color filter stripes R, G and B exactly match each other, the color filter stripes R, G and B may overlap each other on the data lines 171 to enhance the light blocking or they may be spaced apart from each other.

Although the figures show that a pair of partitions forming a pixel electrode 190 are interposed between adjacent data lines 171, the partitions may be separated by a data line 171.

Many of the above-described features of the LCD shown in FIGS. 18-22 may be appropriate to the LCD shown in FIGS. 26 and 27.

Although FIGS. 18-27 show that the pixel electrodes 190, the data lines 171, etc., are curved, they may be straight or orthogonal. In addition, the shapes and the arrangements of the cutouts 191, 271, 271a and 271b and the types and the alignment of the LC layer 300 may be modified.

As described above, the embodiments of the present invention provides the openings at the common electrode, which prevent the increase of the LC capacitance and thus the increase of the storage capacitance, thereby increasing the charging rate of the LC capacitor and the aperture ratio. In addition, the embodiments make the storage electrodes or the drain electrodes face the cutouts of the common electrode, which are curved like the pixel electrodes, thereby increasing the freedom of the pixel design and the storage capacitance as well as the aperture ratio.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A liquid crystal display comprising:
a thin film transistor array panel including
a first gate line,
a data line intersecting the gate line,
a first thin film transistor including a gate electrode connected to the gate line, a source electrode connected to the data line, and a drain electrode,
a first pixel electrode connected to the drain electrode, and
a capacitor electrode overlapping at least one of the pixel electrode and the drain electrode with interposing an insulator; and
a common electrode panel facing the thin film transistor array panel including a common electrode that faces the pixel electrode and has an opening facing at least one of the drain electrode and the capacitor electrode.

2. The liquid crystal display of claim 1, wherein the data line comprises a curved portion and an intersecting portion connected to the curved portion and intersecting the gate line.

3. The liquid crystal display of claim 2, wherein the curved portion of the data line comprises a pair of rectilinear portions connected to each other and making an angle of about 45 degrees with the gate line.

4. The liquid crystal display of claim 2, wherein the pixel electrode is curved along the curved portion of the data line.

5. The liquid crystal display of claim 1, wherein the pixel electrode overlaps the data line at least in part.

6. The liquid crystal display of claim 1, further comprising:
a second gate line separated from the first gate line and the data line and disposed adjacent to the first pixel electrode;
a second thin film transistor connected to the second gate line; and
a second pixel electrode connected to the second thin film transistor.

7. The liquid crystal display of claim 6, wherein the capacitor electrode is connected to the second gate line.

8. The liquid crystal display of claim 7, further comprising a capacitor conductor electrically connected to the pixel electrode and disposed between the capacitor electrode and the pixel electrode.

9. The liquid crystal display of claim 6, wherein the capacitor electrode is disconnected from the second gate line.

10. The liquid crystal display of claim 1, further comprising a color filter disposed on either of the thin film transistor array panel and the common electrode panel.

11. The liquid crystal display of claim 1, further comprising a liquid crystal layer interposed between the thin film transistor array panel and the common electrode panel.

12. The liquid crystal display of claim 11, wherein the liquid crystal layer has negative anisotropy and substantially vertical alignment.

13. The liquid crystal display of claim 12, further comprising a tilt control member controlling tilt directions of molecules in the liquid crystal layer.

14. The liquid crystal display of claim 13, wherein the tilt control member comprises a cutout in the pixel electrode or the common electrode.

15. The liquid crystal display of claim 13, wherein the tilt control member comprises a protrusion on the pixel electrode or the common electrode.

16. The liquid crystal display of claim 1, further comprising a semiconductor layer disposed opposite the gate electrode and including a first portion located between the source electrode and the drain electrode.

17. The liquid crystal display of claim 16, wherein the semiconductor layer further comprises a second portion disposed under the data line.

18. The liquid crystal display of claim 17, wherein the semiconductor layer has substantially the same planar pattern as the data line, the source electrode, and the drain electrode except for the first portion.

19. A thin film transistor array panel comprising:
a substrate;
a gate line formed on the substrate and including a gate electrode;
a data line formed on the substrate and including a curved portion and an intersecting portion crossing the gate line;
a thin film transistor including a gate electrode connected to the gate line, a source electrode connected to the data line, and a drain electrode;
a pixel electrode connected to the drain electrode; and
a storage electrode overlapping at least one of the pixel electrode and the drain electrode with interposing an insulator,
wherein at least one of the drain electrode and the storage electrode includes a portion extending parallel to the curved portion of the data line.

20. The thin film transistor array panel of claim 19, wherein the curved portion of the data line comprises a pair of portions making a clockwise angle of about 45 degrees and a counterclockwise angle of about 45 degrees with respect to the gate line, respectively.

21. The thin film transistor array panel of claim 19, wherein the drain electrode and the storage electrode overlap each other.

22. The thin film transistor array panel of claim 19, wherein the source electrode is connected to the intersecting portion of the data line.

23. The thin film transistor array panel of claim 19, wherein the pixel electrode is curved along the curved portion of the data line.

24. The thin film transistor array panel of claim 19, wherein the pixel electrode overlaps the data line at least in part.

25. The thin film transistor array panel of claim 19, wherein the pixel electrode comprises a pair partitions interposing a cutout therebetween.

26. The thin film transistor array panel of claim 19, further comprising a semiconductor layer disposed opposite the gate electrode and including a first portion located between the source electrode and the drain electrode.

27. The thin film transistor array panel of claim 26, wherein the semiconductor layer further comprises a second portion disposed under the data line.

28. The thin film transistor array panel of claim 27, wherein the semiconductor layer has substantially the same planar pattern as the data line, the source electrode, and the drain electrode except for the first portion.

29. A liquid crystal display comprising:
a thin film transistor array panel including
a substrate,
a gate line formed on the substrate and including a gate electrode,
a data line formed on the substrate and including a curved portion and an intersecting portion crossing the gate line,
a thin film transistor including a gate electrode connected to the gate line, a source electrode connected to the data line, and a drain electrode,
a pixel electrode connected to the drain electrode, and
a storage electrode overlapping at least one of the pixel electrode and the drain electrode with interposing an insulator; and
a common electrode panel facing the thin film transistor array panel including a common electrode that faces the pixel electrode.

30. The liquid crystal display of claim 29, further comprising a color filter disposed on either of the thin film transistor array panel and the common electrode panel.

31. The liquid crystal display of claim 29, further comprising a liquid crystal layer interposed between the thin film transistor array panel and the common electrode panel and having negative anisotropy and substantially vertical alignment.

32. The liquid crystal display of claim 29, further comprising a tilt control member controlling tilt directions of molecules in the liquid crystal layer.

33. The liquid crystal display of claim 32, wherein the tilt control member comprises a cutout in the pixel electrode or the common electrode.

34. The liquid crystal display of claim 32, wherein the tilt control member comprises a protrusion on the pixel electrode or the common electrode.

35. The liquid crystal display of claim 32, wherein the tilt control member is curved in parallel to the data line.

36. The liquid crystal display of claim 35, wherein the tilt control member faces at least one of the drain electrode and the storage electrode.
